(19) United States
(12) Patent Application Publication
(10) Pub. No.: US 2023/0031190 A1
(43) Pub. Date: Feb. 2, 2023

(54) ULTRA-FINE BUBBLE GENERATING UNIT AND ULTRA-FINE BUBBLE-CONTAINING LIQUID MANUFACTURING APPARATUS

(71) Applicant: CANON KABUSHIKI KAISHA, Tokyo (JP)

(72) Inventor: Akira Yamamoto, Kanagawa (JP)

(21) Appl. No.: 17/862,569

(22) Filed: Jul. 12, 2022

(30) Foreign Application Priority Data
Jul. 30, 2021 (JP) 2021-125884

(51) Int. Cl. B01B 1/00; F24H 1/10

(52) U.S. Cl. CPC B01B 1/00; F24H 1/102

(57) ABSTRACT

An ultra-fine bubble generating unit and an ultra-fine bubble-containing liquid manufacturing apparatus. Provided is an ultra-fine bubble generating unit and an ultra-fine bubble-containing liquid manufacturing apparatus capable of maintaining stable UFB generation efficiency and generating a high-quality UFB-containing liquid with less variation. To this end, the number of heating elements arrayed along a direction of a liquid flowing over the heating elements (arrow F1 direction) is n1, and the number of the heating elements arrayed to cross the arrow F1 direction is n2. In this case, a heating element substrate of a UFB generating unit in the present embodiment has a configuration in which a relationship of n1<n2 is satisfied.

### BACKGROUND OF THE INVENTION

### Field of the Invention

The present invention relates to an ultra-fine bubble generating unit and an ultra-fine bubble-containing liquid manufacturing apparatus that generate a liquid containing ultra-fine bubbles (hereinafter, also referred to as “UFBs”) smaller than 1.0 μm in diameter.

### Description of the Related Art

Japanese Patent Laid-Open No. 2019-42732 discloses a method of generating ultra-fine bubbles smaller than 1.0 μm in diameter by heating a heating element in a liquid to make film boiling in the liquid (thermal-ultra fine bubbles; hereinafter, also referred to as “T-UFBs”). Particularly, there is disclosed that the UFBs are generated efficiently by arraying multiple substrates including the heating element along a direction of a flow of the liquid to increase the total number of the heating elements and make the film boiling repeatedly along with the flow of the liquid.

The liquid is affected by heat from the heating elements as the liquid flows over the multiple heating elements arranged on the substrates. Specifically, excessive heat during the bubbling caused by the film boiling is conducted to the liquid, and the temperature of the liquid rises as the liquid flows downstream. There is a risk that, if the temperature of the liquid rises, a dissolved gas in the liquid is formed into air bubbles, and the amount of the dissolved gas may be reduced. If the amount of the dissolved gas in the liquid is reduced, the amount of the generated UFBs is reduced. However, in Japanese Patent Laid-Open No. 2019-42732, there is no mention of suppressing the reduction in the amount of the dissolved gas along with the temperature rise in the liquid.

There is also a risk that an air bubble in large size that is generated because the dissolved gas is formed into air bubbles may inhibit the bubbling caused by the film boiling on the heating elements on the downstream side.

### SUMMARY OF THE INVENTION

Therefore, the present invention provides an ultra-fine bubble-containing liquid manufacturing apparatus and an ultra-fine bubble generating unit that are capable of maintaining stable UFB generation efficiency and generating a high-quality UFB-containing liquid with less variation.

An ultra-fine bubble generating unit of the present invention is an ultra-fine bubble generating unit configured to generate ultra-fine bubbles in a liquid by heating a plurality of heating elements to make film boiling in the liquid, the ultra-fine bubble generating unit including: a substrate including the heating elements, supplying ports that allow for supplying of the liquid to the heating elements, and a flow passage to guide the liquid supplied from the supplying ports to the heating elements. Here, a relationship of n1<n2 is satisfied in the substrate where the number of the heating elements arranged along a first direction, which is a direction in which the liquid flows to the heating elements in the flow passage, is n1, and the number of the heating elements arranged along a second direction, which is a direction crossing the first direction, is n2.

According to the present invention, it is possible to provide an ultra-fine bubble generating unit and an ultra-fine bubble-containing liquid manufacturing apparatus that are capable of maintaining stable UFB generation efficiency and generating a high-quality UFB-containing liquid with less variation.

Further features of the present invention will become apparent from the following description of exemplary embodiments with reference to the attached drawings.

### BRIEF DESCRIPTION OF THE DRAWINGS

FIG. 1 is a schematic configuration diagram illustrating an ultra-fine bubble-containing liquid manufacturing apparatus;

FIG. 2 is a perspective view of a UFB generating unit;

FIG. 3 is a perspective view of the UFB generating unit;

FIG. 4 is an exploded perspective view of the UFB generating unit;

FIG. 5 is an exploded perspective view of a heating element substrate;

FIG. 6 is a cross-sectional view taken along VI-VI in FIG. 2;

FIG. 7 is an exterior view of a housing that is illustrated to describe the inside;

FIG. 8 is a cross-sectional view of the UFB generating unit in which a direction of a flow of a liquid is vertically upward;

FIG. 9 is a diagram illustrating a heating element substrate of a modification;

FIG. 10 is a diagram illustrating the heating element substrate of a modification;

FIG. 11 is a schematic configuration diagram illustrating a UFB-containing liquid manufacturing apparatus;

FIG. 12 is a perspective view illustrating a UFB generating unit;

FIG. 13 is a perspective view illustrating the UFB generating unit;

FIG. 14 is an exploded perspective view of the UFB generating unit;

FIG. 15 is a cross-sectional view taken along XV-XV in FIG. 12;

FIG. 16 is a cross-sectional view illustrating the UFB generating unit;

FIG. 17 is a schematic configuration diagram illustrating a UFB-containing liquid manufacturing apparatus;

FIG. 18 is a perspective view illustrating an exterior of a UFB generating unit;

FIG. 19 is an exploded perspective view of the UFB generating unit;

FIG. 20 is an exploded perspective view of a heating element substrate;

FIG. 21 is a cross-sectional view taken along XXI-XXI in FIG. 18;

FIG. 22 is a perspective view illustrating an exterior of a UFB generating unit;

FIG. 23 is an exploded perspective view of the UFB generating unit;

FIG. 24 is an exploded perspective view of a heating element substrate;

FIG. 25A is a cross-sectional view of the UFB generating unit;

FIG. 25B is a cross-sectional view of the UFB generating unit;

FIG. 26 is a diagram describing a flow of the liquid in the heating element substrate;

FIG. 27 is a perspective view illustrating an exterior of a UFB generating unit; and

FIG. 28 is an exploded perspective view of the UFB generating unit.

### DESCRIPTION OF THE EMBODIMENTS

### First Embodiment

A first embodiment of the present invention is described below with reference to the drawings.

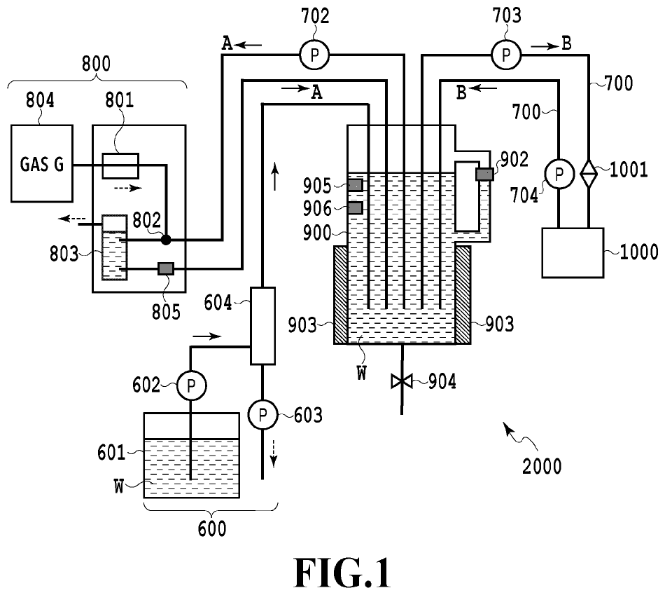

FIG. 1 is a schematic configuration diagram illustrating an ultra-fine bubble-containing liquid manufacturing apparatus (hereinafter, referred to as a UFB-containing liquid manufacturing apparatus) 2000 in the present embodiment. The UFB-containing liquid manufacturing apparatus 2000 includes a liquid supplying unit 600, a gas dissolving unit 800, a storing chamber 900, and an ultra-fine bubble generating unit (hereinafter, referred to as a UFB generating unit) 1000 as main components. In FIG. 1, a solid line arrow indicates a flow of a liquid, and a broken line arrow indicates a flow of a gas.

The liquid supplying unit 600 includes a liquid retaining unit 601, two pumps 602 and 603, and a degassing unit 604 as main components. A liquid W retained in the liquid retaining unit 601 is transferred by the pump 602 to the storing chamber 900 through the degassing unit 604. A film that allows only the gas to pass therethrough is arranged inside the degassing unit 604. With depressurizing by the pump 603, only the gas passes through the film, and thus the gas and the liquid are separated from each other. After the separation, the liquid W is transferred to the storing chamber 900, and the gas is ejected to the outside. Various gases may be dissolved in the liquid retained in the liquid retaining unit 601; however, with the dissolved gases being removed by the degassing unit 604 before the liquid is transferred to the storing chamber 900, it is possible to enhance the dissolving efficiency in a gas dissolving step performed later.

The gas dissolving unit 800 includes a gas supplying unit 804, a pre-processing unit 801, a converging unit 802, and a gas-liquid separating chamber 803. The gas supplying unit 804 may be a cylinder that preserves a desired gas G or may be a device that is capable of continuously generating the desired gas G. For example, in a case where the desired gas G is oxygen, there may be applied a device that takes in the atmospheric air, removes nitrogen, and continuously transfers by a pump the gas from which nitrogen is removed.

The gas G supplied by the gas supplying unit 804 is subjected to processing such as electric discharge by the pre-processing unit 801 and thereafter converged with the liquid W flowing out from the storing chamber 900 in the converging unit 802. In this process, a part of the gas G is dissolved into the liquid W. The converged gas G and liquid W are separated from each other again by the gas-liquid separating chamber 803, and only the gas G that is not dissolved in the liquid W is ejected to the outside. The liquid W in which the gas G is dissolved is thereafter transferred to the UFB generating unit 1000 by a pump 703. A solubility sensor 805 that detects the solubility of the gas Gin the liquid W is provided downstream of the gas-liquid separating chamber 803.

The storing chamber 900 stores a mixed liquid of the liquid W that is supplied from the liquid supplying unit 600, the liquid W in which the desired gas G is dissolved by the gas dissolving unit 800, and the UFB-containing liquid in which the T-UFBs are generated by the UFB generating unit 1000. A temperature sensor 905 detects the temperature of the liquid W stored in the storing chamber 900. A liquid surface sensor 902 is arranged at a predetermined height of the storing chamber 900 and detects the liquid surface of the liquid W. A UFB concentration sensor 906 detects the UFB concentration of the liquid W stored in the storing chamber 900. A valve 904 is opened in a case of ejecting the liquid W stored in the storing chamber 900 to a not-illustrated external container. Although it is not illustrated, an agitating unit that uniforms the temperature of the liquid W and the distribution of the UFBs may be provided inside the storing chamber 900.

A cooling unit 903 cools the liquid W stored in the storing chamber 900. In order to efficiently dissolve the desired gas G by the gas dissolving unit 800, it is preferred that the temperature of the liquid W to be supplied to the gas dissolving unit 800 is as low as possible. With the temperature of the liquid W to be circulated being kept at a low temperature, it is possible to suppress a temperature rise of the liquid W in the UFB generating unit 1000 that generates the UFBs by using the film boiling and to extend the life of the UFB generating unit 1000. In the present embodiment, the cooling unit 903 is used while the temperature of the liquid W is detected by the temperature sensor 905, and thus the temperature of the liquid W to be supplied to the gas dissolving unit 800 is adjusted to be equal to or lower than 10° C.

The configuration of the cooling unit 903 is not particularly limited; however, for example, it is possible to employ a method such as a method using a Peltier element or a method of circulating a liquid cooled by a chiller. In a case of the latter, a cooling pipe circulating a coolant may be wound around an outer periphery of the storing chamber 900 as illustrated in FIG. 1, or the storing chamber 900 may have a hollow structure to arrange the cooling pipe in the hollow. There may be applied a configuration in which the cooling pipe is immersed in the liquid W in the storing chamber 900.

The UFB generating unit 1000 generates the UFBs in the liquid W that flows therein. As a method of generating the UFBs, a T-UFB method using the film boiling is employed in the present embodiment. A filter 1001 is arranged upstream of the UFB generating unit 1000, and the filter 1001 prevents impurities, dust, and the like from flowing into the UFB generating unit 1000. With the filter 1001 removing the impurities, dust, and the like, it is possible to improve the efficiency of generating the UFBs in the UFB generating unit 1000.

The above-described units are connected with each other by a piping 700, and a route through which the liquid W is circulated is formed by arranging pumps 702, 703, and 704. In FIG. 1, there is illustrated a case where a circulation route A for dissolving the gas and a circulation route B for generating the UFBs are formed. In this case, in the circulation route A, in order to efficiently dissolve the gas, the liquid W is circulated with a flow velocity of about 300 to 3000 mL/min and a pressure of about 0.2 to 0.6 MPa. In the circulation route B, the liquid W is circulated with a flow velocity of about 10 to 300 mL/min and a pressure of about 0.1 to 0.3 MPa. In the T-UFB method, the UFBs are generated by using a pressure difference and heat that occur in a process from the bubbling to the bubble disappearance caused by the film boiling; for this reason, relatively low velocity and low pressure (atmospheric air pressure) are preferred as the circulation conditions.

In FIG. 1, there is illustrated a configuration in which the circulation route A for dissolving the gas is provided; however, a configuration in which a certain amount of the gas G is directly supplied to the storing chamber 900 may be applied. With this, it is possible to implement a UFB-containing liquid manufacturing apparatus that is further downsized.

The positions and the number of the pumps are not limited to that illustrated in FIG. 1. Additionally, as needed, the configuration of each unit may be provided with a pump and a valve necessary for operations of the corresponding unit. Note that, as the pumps, it is favorable to use a pump with a small variation in pulsation and flow rate so as not to reduce the efficiency of generating the UFBs. Moreover, a collecting passage and the valve 904 for collecting the liquid W may not be provided in the storing chamber 900 and may be provided in other positions in the circulation route of the liquid. Furthermore, in a case where a temperature rise of the UFB generating unit 1000 is rapid, a cooling unit similar to that for the storing chamber 900 may be provided also in the UFB generating unit 1000.

The solubility sensor 805, the temperature sensor 905, and the UFB concentration sensor 906 may be provided in other positions as long as they are within the circulation route. Those sensors may be provided in multiple positions within the circulation route to have a configuration capable of outputting an average value. It is favorable for a member that is put in contact with the UFB-containing liquid such as the piping 700, the pumps 702, 703, and 704, the filter 1001, the storing chamber 900, and the UFB generating unit 1000 to be formed of a material with strong resistance to corrosion. For example, fluorine system resin such as polytetrafluoroethylene (PTFE) and perfluoroalkoxy alkane (PFA), metal such as SUS316L, and other inorganic materials are favorably usable. With this, it is possible to favorably generate the UFBs even in a case where the gas G and the liquid W with strong resistance to corrosion are used.

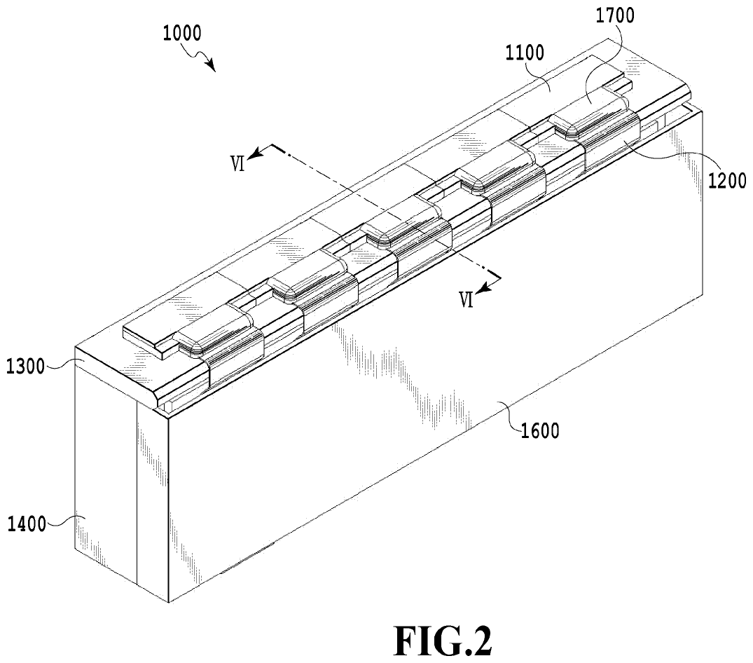

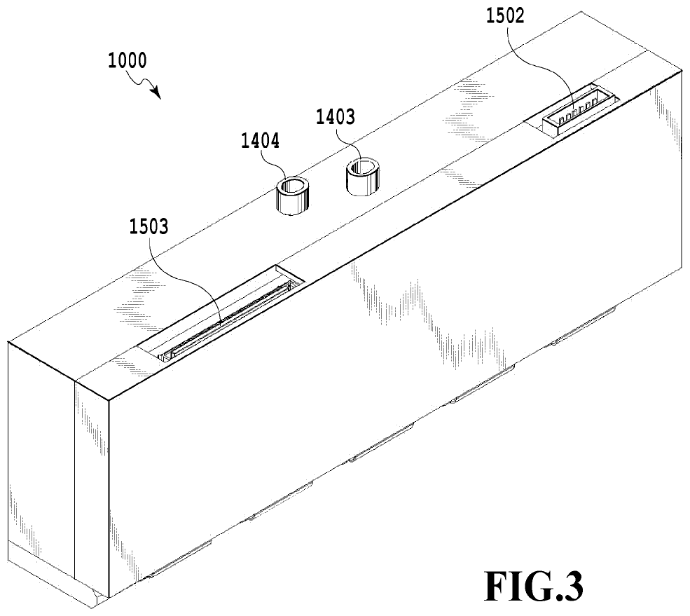

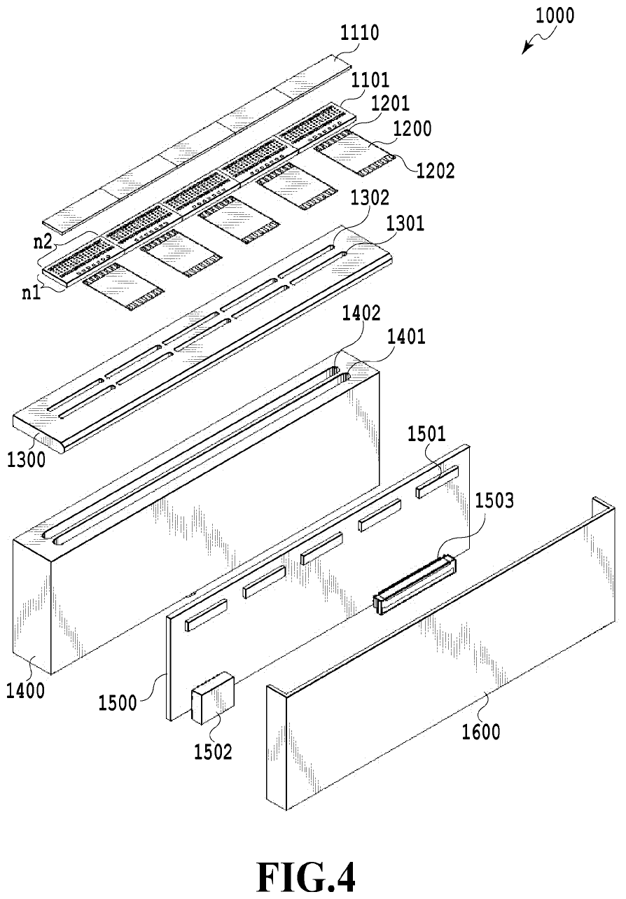

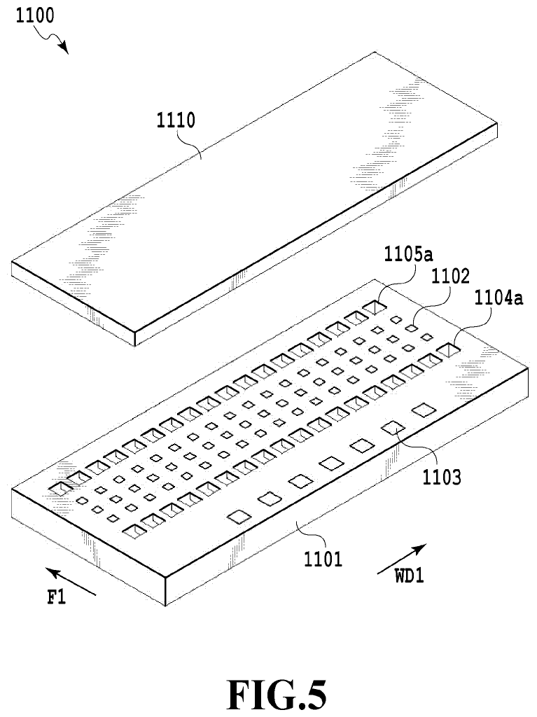

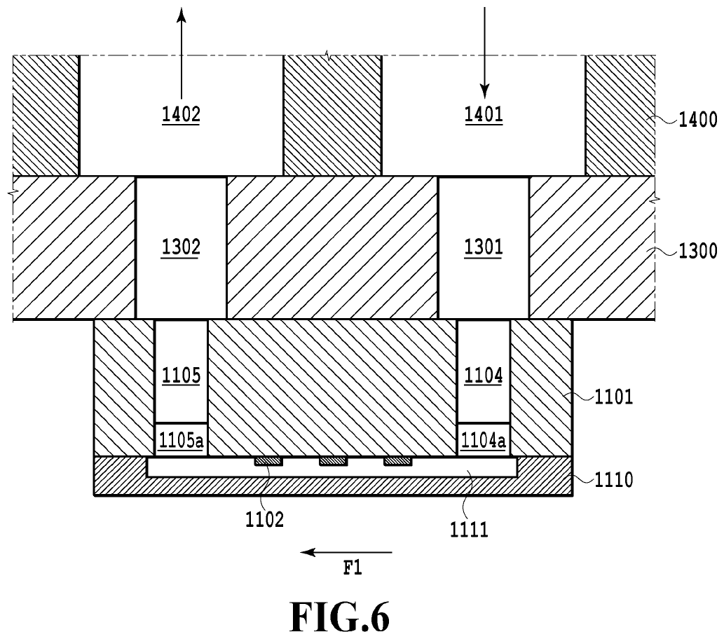

FIGS. 2 and 3 are perspective views of the UFB generating unit 1000 in the present embodiment, and FIG. 4 is an exploded perspective view of the UFB generating unit 1000. FIG. 5 is an exploded perspective view of a heating element substrate 1100, and FIG. 6 is a cross-sectional view taken along VI-VI in FIG. 2.

As illustrated in FIG. 4, the UFB generating unit 1000 in the present embodiment includes the heating element substrate 1100, a flexible wiring substrate 1200, a support member 1300, a housing 1400, an electric substrate 1500, and a cover 1600. In the heating element substrate 1100, a first flow passage member 1110 (see FIG. 5) and an Si substrate 1101 are laminated, and on the Si substrate 1101, many heating elements 1102 (see FIG. 5) and electrodes 1103 (see FIG. 5) are provided. The heating elements 1102 and the electrodes 1103 are connected to each other with not-illustrated wiring. In a desired timing, an electric signal is transmitted from the electrodes 1103 and the heating elements 1102 (see FIG. 5) are driven. In the Si substrate 1101, there are formed supplying ports 1104a (see FIG. 5) that allow for supplying of the liquid to the heating elements 1102 and collecting ports 1105a (see FIG. 5) that allow for collecting of the liquid W that has passed through the heating elements 1102.

The multiple supplying ports 1104a are connected to and communicate with a supplying passage 1104 (see FIG. 6) at a lower portion. Likewise, the collecting ports 1105a are connected to and communicate with a collecting passage 1105. With such a configuration, a beam of Si is formed between the supplying ports 1104a and the collecting ports 1105a. The beam serves to maintain the rigidity of the Si substrate 1101 and to route the wiring. On a top portion of the Si substrate 1101, the first flow passage member 1110 (see FIGS. 5 and 6) is provided, and a flow passage 1111 (see FIG. 6) that guides the liquid to the multiple heating elements 1102 is formed. These are all formed with high dimensional accuracy by a photolithography step. The support member 1300 (see FIGS. 4 and 6) is formed of a member such as alumina and has a function of supporting and fixing the multiple heating element substrates 1100 and releasing the heat generated by the heating elements 1102. In the support member 1300, a supplying passage 1301 and a collecting passage 1302 are provided in positions corresponding to the supplying passage 1104 and the collecting passage 1105 (see FIG. 6), respectively.

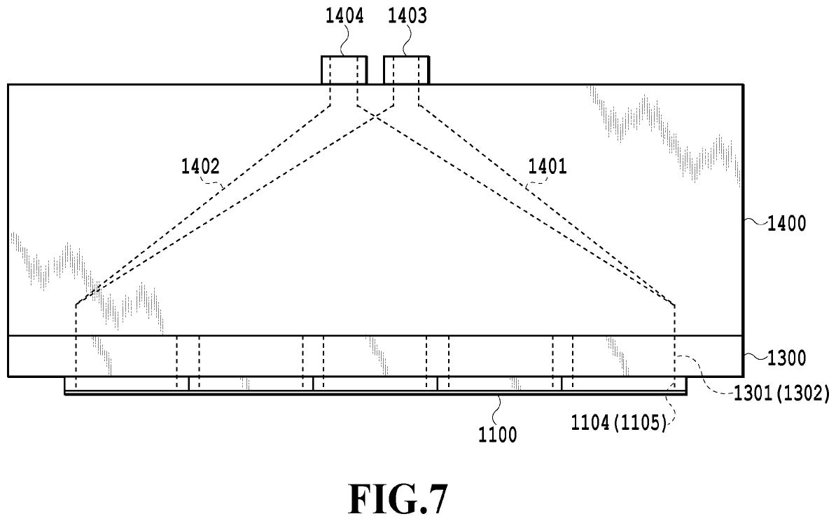

FIG. 7 is a transparent view illustrated to describe the inside of the housing 1400 viewed from a longitudinal direction. The housing 1400 is formed of a mold member. In the housing 1400, a supplied liquid chamber 1401 and a collected liquid chamber 1402 that are shared by and corresponding to the multiple heating element substrates 1100 are provided, and connecting portions 1403 and 1404 to make fluid communication with the outside are provided. The shape of the supplied liquid chamber 1401 and the collected liquid chamber 1402 is a taper shape as illustrated in FIG. 7, and thus each of the heating element substrates 1100 is stably supplied with the liquid W at the substantially same temperature. An electric signal (power) is transmitted to the heating element substrate 1100 through the electric substrate 1500 and the flexible wiring substrate 1200 (see FIG. 4). On the electric substrate 1500, connectors 1502 and 1503 (see FIG. 4) are formed, and the electric substrate 1500 is electrically connected with a UFB generating unit driving unit. A connector 1501 and a terminal 1202 of the flexible wiring substrate 1200 are connected with each other.

A terminal 1201 of the flexible wiring substrate 1200 and the electrodes 1103 of the heating element substrate 1100 are electrically connected to each other with wire bonding or the like and are sealed with a sealing material 1700 (see FIG. 2). The electric substrate 1500 is protected by the cover 1600 (see FIG. 2) formed of a mold member, sheet metal, or the like. The UFB generating unit 1000 is easily attachable to and detachable from the UFB-containing liquid manufacturing apparatus 2000. In the present specification, a member including a single heating element substrate 1100 and a single flexible wiring substrate 1200 is referred to as a UFB generating module. In the UFB generating unit 1000, multiple UFB generating modules as described above can be arranged, and in the present embodiment, there is described an example in which five ultra-fine bubble generating modules are arrayed in the longitudinal direction.

As illustrated in FIG. 6, the liquid W supplied to the UFB generating unit 1000 is transferred to the heating elements 1102 through the supplied liquid chamber 1401, the supplying passage 1301, the supplying passage 1104, and the flow passage 1111. The liquid W is then collected through the flow passage 1111, the collecting passage 1105, the collecting passage 1302, and the collected liquid chamber 1402. That is, the liquid W flows in an arrow F1 direction over the heating elements 1102. The arrow F1 direction is a transverse direction of the heating element substrate 1100 and is also the transverse direction of the array of the heating elements 1102.

Like the present embodiment, in a case of a configuration in which the flow passage member 1110 in which the flow passage of the liquid is formed is laminated on the Si substrate 1101 in which the multiple heating elements are arranged, it is possible to make the UFB generating unit 1000 compact; however, it is difficult to suppress the temperature rise of the liquid under the limited inner volume of the flow passage. To deal with this, in the present embodiment, the number of the heating elements 1102 arrayed in the transverse direction of the heating element substrate 1100 (arrow F1 direction) is smaller than the number of the heating elements 1102 arrayed in the longitudinal direction (arrow WD1 direction (see FIG. 5) of the heating element substrate 1100). As illustrated in FIG. 4, the number of the heating elements 1102 arrayed along the direction of the liquid W flowing over the heating elements 1102 (arrow F1 direction) is n1, and the number of the heating elements arrayed in a direction crossing the arrow F1 direction is n2. In this case, the heating element substrate 1100 of the UFB generating unit 1000 in the present embodiment has a configuration in which a relationship of n1<n2 is satisfied.

In this case, n1, which is the number of the arrayed heating elements 1102 in the arrow F1 direction, may be calculated by estimating how much the temperature of the liquid rises based on the amount of the dissolved gas, the temperature of the supplied liquid, the drive frequency of the heating elements, and the like during the UFB generation in the flow passage 1111. Specifically, based on the estimated value of the temperature rise, n1 may be set to the number that makes no difference in the amount of the generated UFBs between upstream and downstream of the flow over n1 pieces of the heating elements. The number of the heating element substrates 1100 can be determined arbitrarily depending on a capacity to manufacture a desired UFB-containing liquid. As described above, with the number of the heating elements 1102 in the arrow F1 direction in which the liquid flows during the UFB generation being limited, it is possible to suppress the temperature rise of the liquid during the UFB generation in the flow passage 1111, and it is possible to suppress a reduction in the amount of the dissolved gas in the liquid. With this, it is possible to increase the total number of the heating elements 1102 included in the UFB generating unit 1000 without a difference in the UFB generation quality between upstream and downstream of the flow of the liquid W, and it is possible to stably generate the UFBs without reducing the efficiency.

It is desirable that the arrow WD1 direction (see FIG. 5) is orthogonal to the arrow F1 direction, and this makes it possible to implement a compact UFB generating unit 1000. However, it is not limited thereto, and the arrow WD1 direction may be crossed at an incline of a range from about 45° to 90°. The shape of the heating element substrate 1100 is not limited to a rectangular and may be an arbitrary shape.

FIG. 4 illustrates a diagram in which the multiple heating element substrates 1100 are arrayed; however, it is also possible to apply a configuration in which the heating elements 1102 are mounted as a single heating element substrate 1100, with the number of the heating elements 1102 being comparable to the number in a case of arraying the multiple heating element substrates 1100. The timing of driving (bubbling) of the multiple heating elements 1102 may be properly adjusted. For example, as long as the driving is performed at a relatively low frequency, it is also possible to drive all the heating elements 1102 concurrently. In a case where the driving is performed at a relatively high frequency, it is also possible to perform the driving while staggering the driving at about few micro-second intervals to avoid a voltage drop due to a flow of a great current. In this case, it is also possible to drive the heating elements 1102 from the downstream side to the upstream side. If the heating elements 1102 on the downstream side are driven first, the temperature of the liquid W in the vicinity rises slightly, and the liquid W at the raised temperature is moved downstream by the flow of the liquid (flow in the arrow F1 direction). Thus, the heating elements 1102 on the upstream side are less likely to be affected by the temperature rise due to the heating elements 1102 on the downstream side, and it is possible to generate the UFBs further accurately.

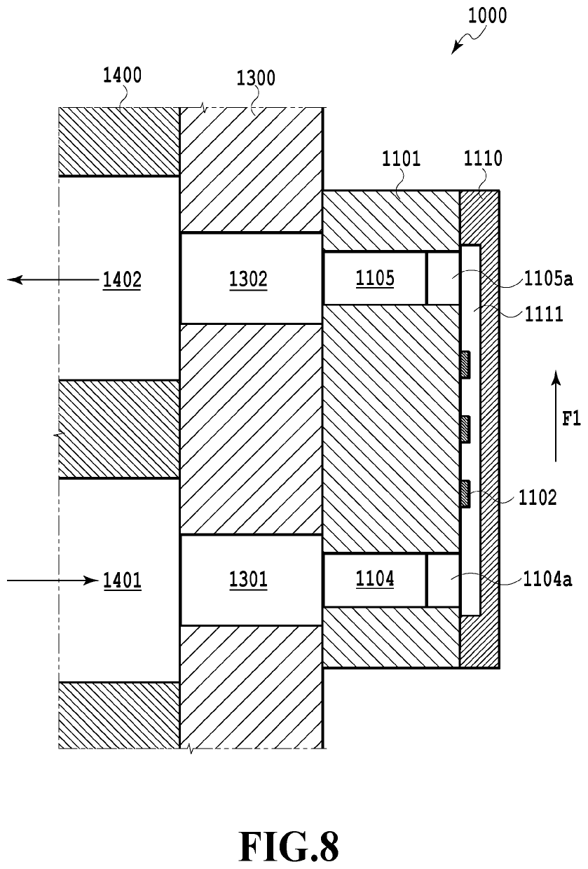

FIG. 8 is a cross-sectional view of the UFB generating unit 1000 in a case where the direction of the flow of the liquid W (arrow F1 direction) is vertically upward. The direction (orientation) of the UFB generating unit 1000 during the UFB generation may be arbitrarily determined and, for example, as illustrated in FIG. 8, the flow direction of the liquid W (arrow F1 direction) in the portion of the heating elements 1102 may be vertically upward. With such a configuration, even in a case where an unexpected large air bubble is mixed to the inside of the UFB generating unit 1000 or a case where an air bubble is generated in the portion of the flow passage 1111 due to a rise in the liquid temperature, the air bubble is transferred to the collecting passage 1105 with buoyancy. Therefore, the bubbling by the heating elements 1102 is less likely to be inhibited, and it is possible to perform the stable UFB generation.

### Modifications

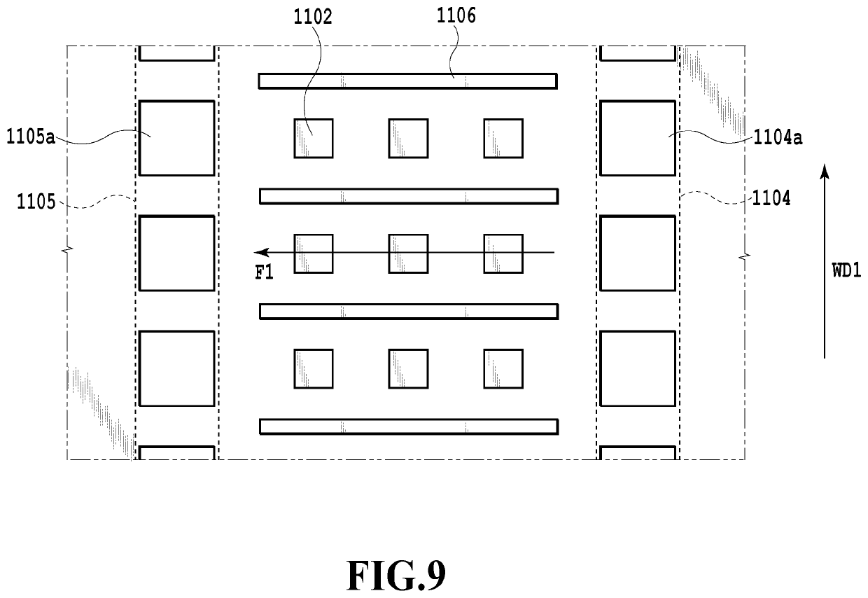

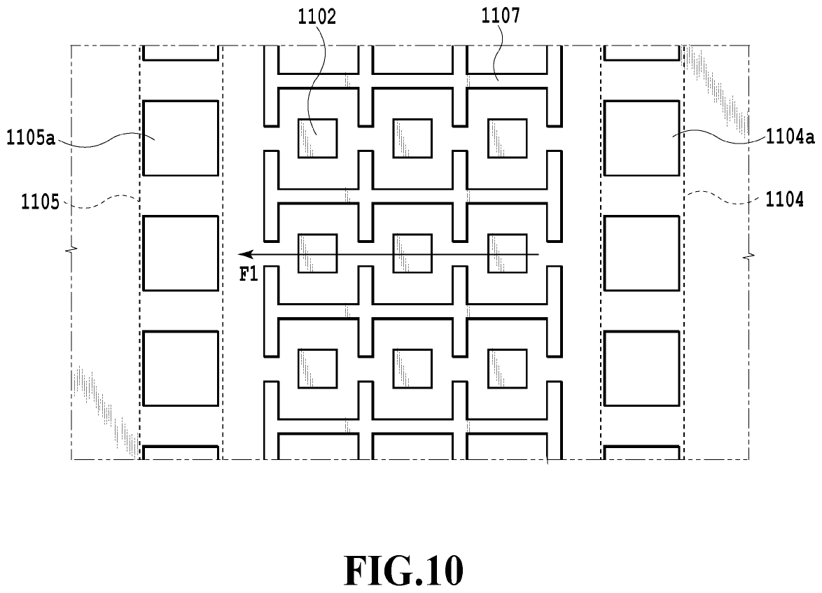

FIGS. 9 and 10 are diagrams illustrating the heating element substrate 1100 of modifications of the present embodiment. In the heating element substrate 1100 illustrated in FIG. 9, a partition portion 1106 is provided along the arrow F1 direction between the heating elements 1102 that are adjacent to each other in the arrow WD1 direction. With such a partition portion 1106 being provided, it is possible to suppress the flow of the liquid in the arrow WD1 direction, and it is possible to suppress a temperature rise of the liquid W; thus, it is possible to generate the UFBs more stably.

In the heating element substrate 1100 illustrated in FIG. 10, a partition portion 1107 is provided to surround each of the heating elements 1102 except a part in the arrow F1 direction. With such a partition portion 1107 being provided, it is possible to reduce the effect of the bubbling by an adjacent heating element 1102 in the arrow Fl direction, suppress the bubble disappearance of the generated UFBs, and generate the UFBs more stably even in a case of driving the heating elements 1102 at a high frequency.

As described above, the number of the heating elements 1102 arrayed along the direction of the liquid flowing over the heating elements 1102 (arrow F1 direction) is n1, and the number of the heating elements arrayed to cross the arrow F1 direction is n2. In this case, the heating element substrate 1100 of the UFB generating unit 1000 in the present embodiment has the configuration in which the relationship of n1<n2 is satisfied. With this, it is possible to provide a heating element substrate, an ultra-fine bubble generating unit, and an ultra-fine bubble-containing liquid manufacturing apparatus that are capable of maintaining the stable UFB generation efficiency in the flow passage 1111 and generating a high-quality UFB-containing liquid with a small variation.

### Second Embodiment

A second embodiment of the present invention is described below with reference to the drawings. The basic configuration of the present embodiment is similar to that of the first embodiment; for this reason, a characteristic configuration is described below.

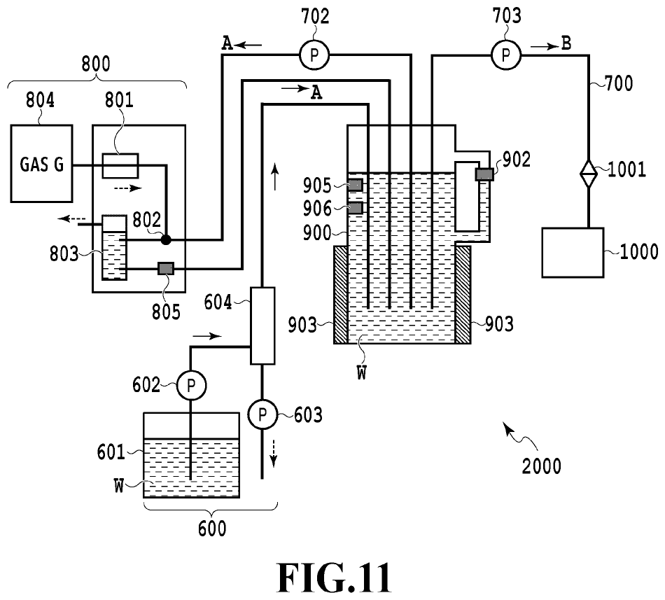

FIG. 11 is a schematic configuration diagram illustrating the UFB-containing liquid manufacturing apparatus 2000 in the present embodiment. In the UFB-containing liquid manufacturing apparatus 2000 in the present embodiment, the generated UFB-containing liquid is not collected to the storing chamber 900 and is directly used as the UFB-containing liquid.

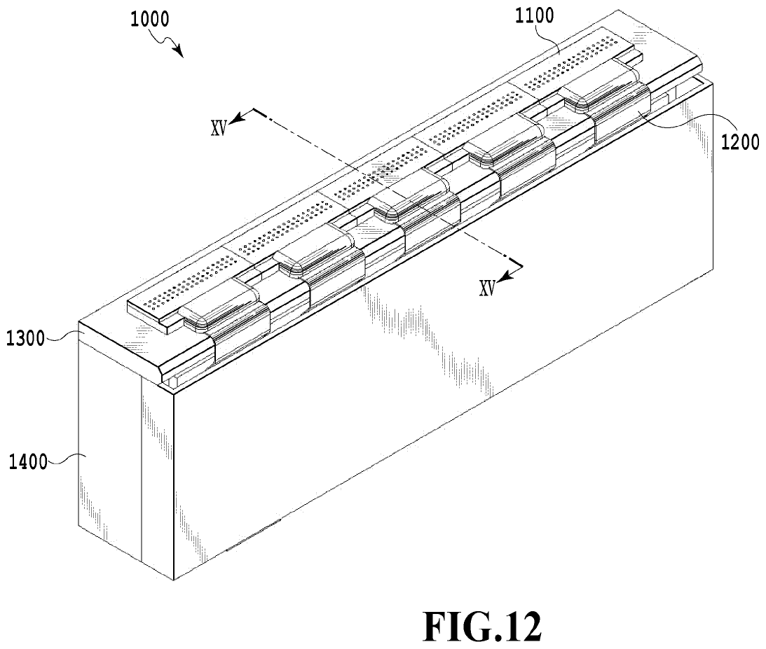

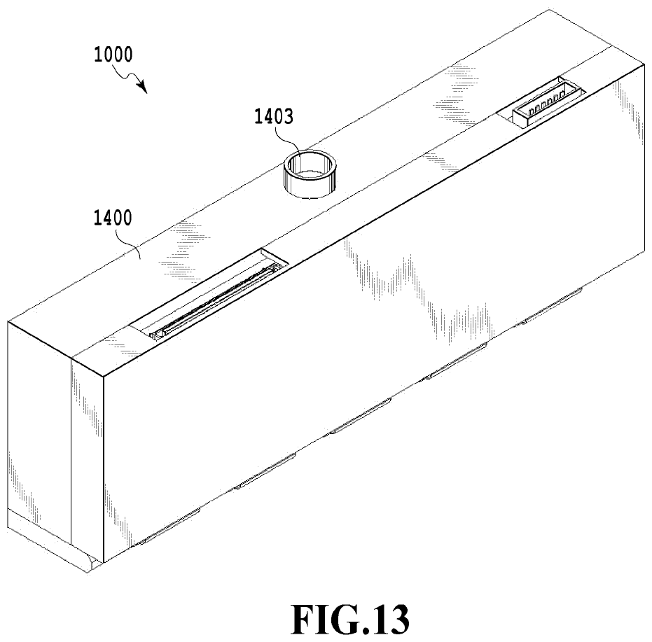

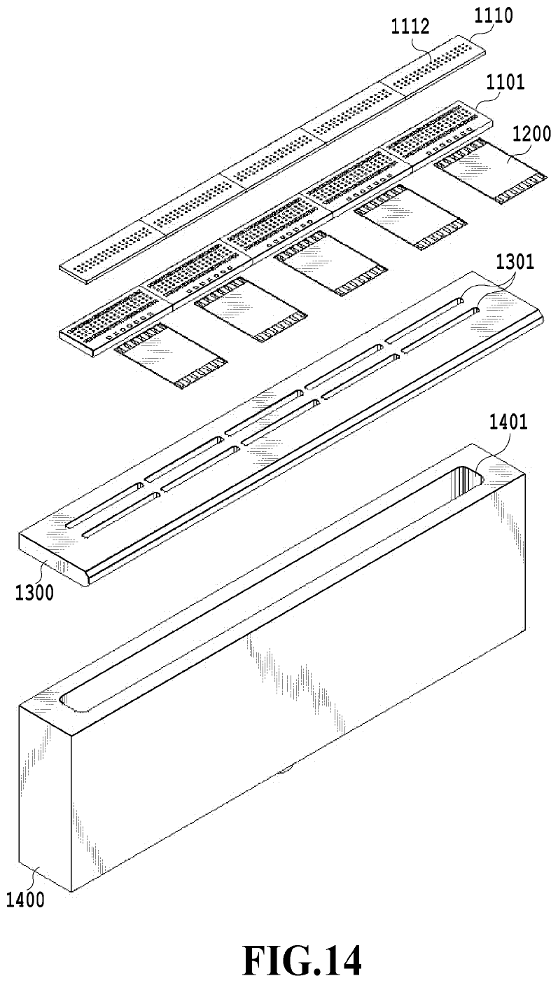

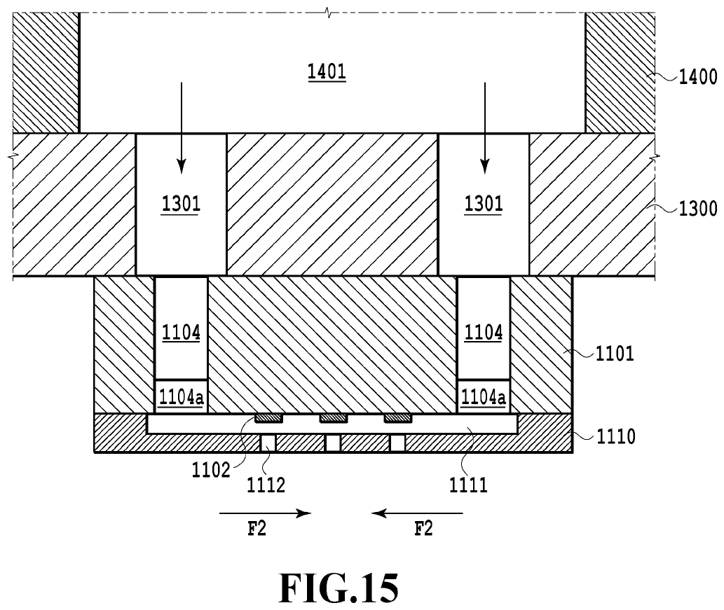

FIGS. 12 and 13 are perspective views illustrating the UFB generating unit 1000 in the present embodiment, and FIG. 14 is an exploded perspective view of the UFB generating unit 1000. FIG. 15 is a cross-sectional view taken along XV-XV in FIG. 12. In FIG. 14, the electric substrate 1500 and the cover 1600 are omitted since they are similar to that in the first embodiment.

In the UFB generating unit 1000 in the present embodiment, ejecting ports 1112 are provided in positions corresponding to the heating elements 1102 in the first flow passage member 1110. In a case where the liquid W bubbles by the driving of the heating elements 1102, the ejecting ports 1112 allow for ejecting of the liquid W containing the UFBs above the heating elements 1102, and the liquid W is ejected from the ejecting ports 1112 in the form of fine droplets. Thus-ejected fine droplets can be applied as a UFB-containing liquid in the form of mist.

The UFB generating unit 1000 of the present embodiment has a configuration in which the UFB-containing liquid is not collected to the storing chamber 900. Accordingly, no connecting portion used for collecting is provided, and a connecting portion 1403 for supplying (see FIG. 13) and the supplied liquid chamber 1401 (see FIG. 14) are formed in the housing 1400. The shape of the support member 1300 is the same as that described in the first embodiment; however, all the opening portions function as the supplying passage 1301. No collecting passage is provided neither in the Si substrate 1101, and the supplying passage 1104 (see FIG. 15) used to supply the liquid is provided. Therefore, the flow of the liquid W flowing over the heating elements 1102 is a flow in an arrow F2 direction illustrated in FIG. 15.

In the present embodiment, here is described that the liquid W containing the UFBs above the heating elements 1102 is ejected from the ejecting ports 1112 in the form of fine droplets in a case where the liquid W bubbles by the driving of the heating elements 1102. If the liquid W heated by the driving of the heating elements 1102 is all ejected from the ejecting ports 1112, the liquid W is never heated repeatedly, and it is considered that there is only a small effect of the temperature rise on the UFB generation. However, in reality, the liquid W heated by the bubbling by the heating elements 1102 is not all ejected from the ejecting ports 1112, and there is also the liquid W that is heated but not ejected. For this reason, the liquid W that is heated but not ejected is heated again by the driving of the heating elements 1102. Therefore, in order to suppress the heating of the liquid and stably generating the UFBs, it is effective to set the number of the heating elements 1102 arrayed along the arrow F2 direction to n1 to be the small number as described in the present embodiment.

### First Modification

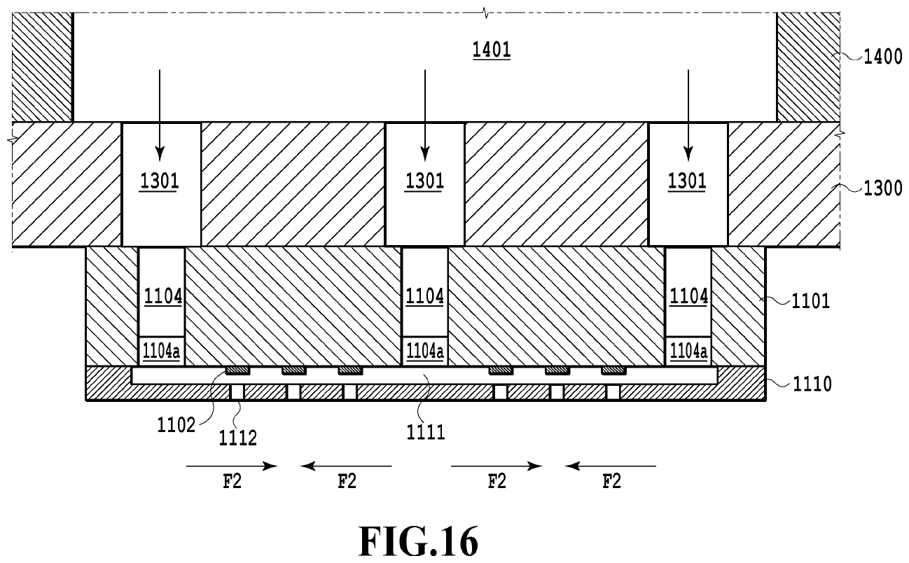

FIG. 16 is a cross-sectional view illustrating the UFB generating unit 1000 and is a diagram illustrating a first modification in the present embodiment. As illustrated in FIG. 16, the number of the supplying passages 1301 and the supplying passages 1104 to be provided is able to be set arbitrarily, and a configuration in which the number of the supplying passages 1301 and the supplying passages 1104 is increased may be applied. As described above, with the number of the supplying passages 1301 and the supplying passages 1104 being increased, it is possible to increase the number of the heating elements 1102 in the arrow F2 direction and increase the amount of the generated UFBs. In the present modification, n1, which is the number of the heating elements 1102 arrayed along the direction of the flow of the liquid (arrow F2 direction), is the number of the heating elements 1102 between adjacent supplying passages 1104. That is, in a case of FIG. 16, n1=3. It is also possible to reduce the in-plane temperature distribution of the heating element substrate 1100 by properly changing flow passage widths of the supplying passage 1301 and the supplying passage 1104.

### Second Modification

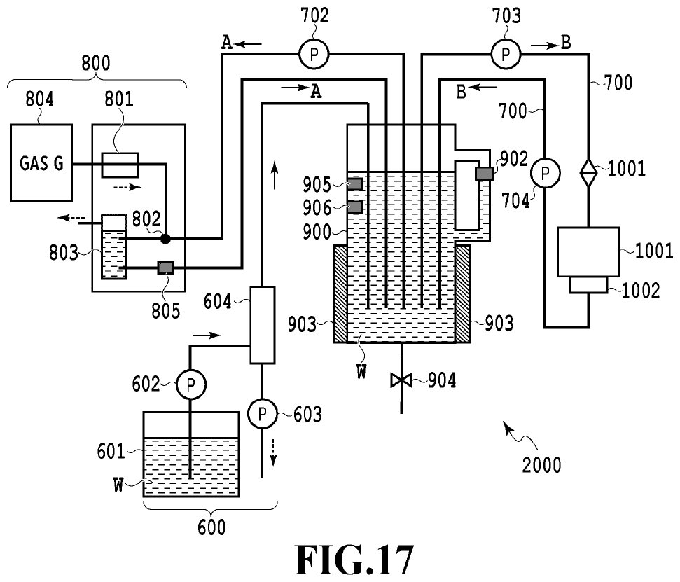

FIG. 17 is a schematic configuration diagram illustrating the UFB-containing liquid manufacturing apparatus 2000 and is a diagram illustrating a second modification in the present embodiment. As illustrated in FIG. 17, a configuration in which a collecting member 1002 that collects the UFB-containing liquid ejected from the ejecting ports 1112 of the UFB generating unit 1000 is attached to the UFB generating unit 1000 to collect the ejected fine droplets by the storing chamber 900 may be applied. It is also possible to take out the UFB-containing liquid at a desired concentration by a circulation operation from the storing chamber 900 by opening the valve 904, and it is also possible to detach the collecting member 1002 and apply the UFB-containing liquid as the ejected UFB-containing liquid in the form of mist.

### Third Embodiment

A third embodiment of the present invention is described with reference to the drawings. The basic configuration of the present embodiment is similar to that of the first embodiment; for this reason, a characteristic configuration is described below.

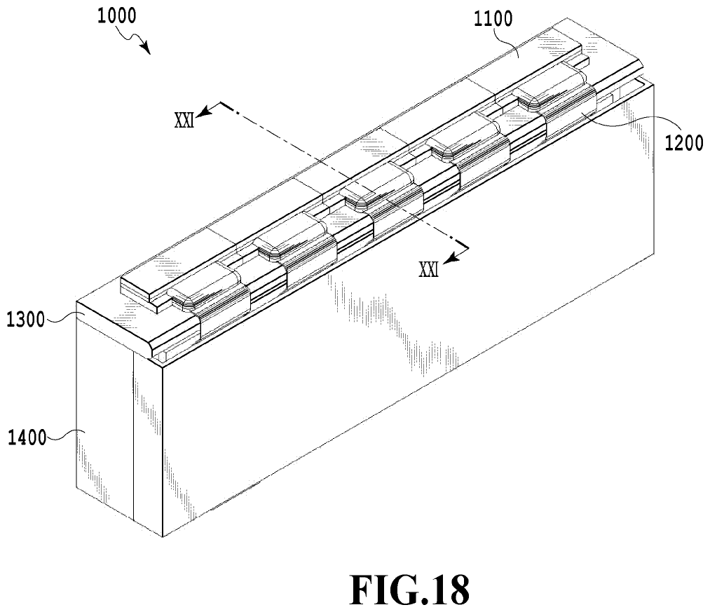

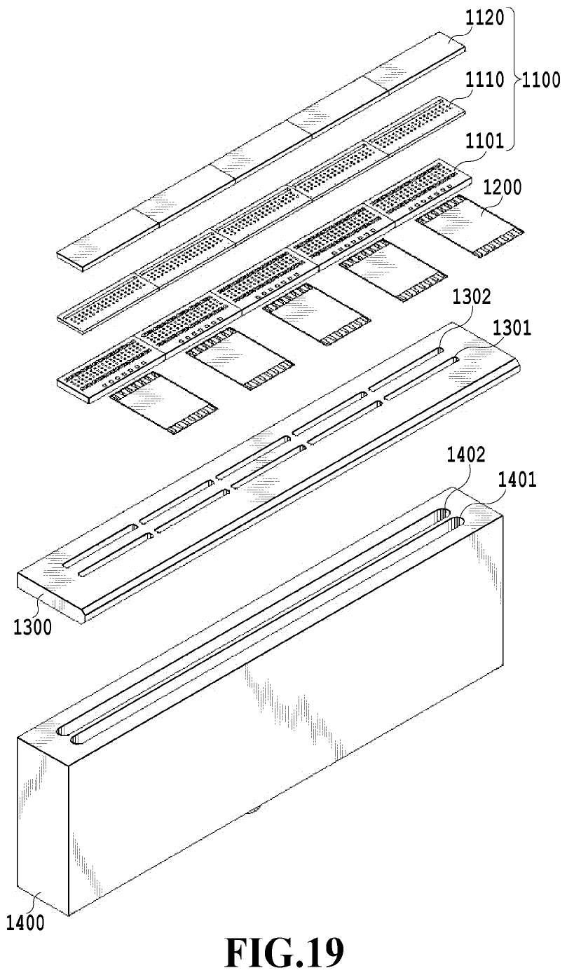

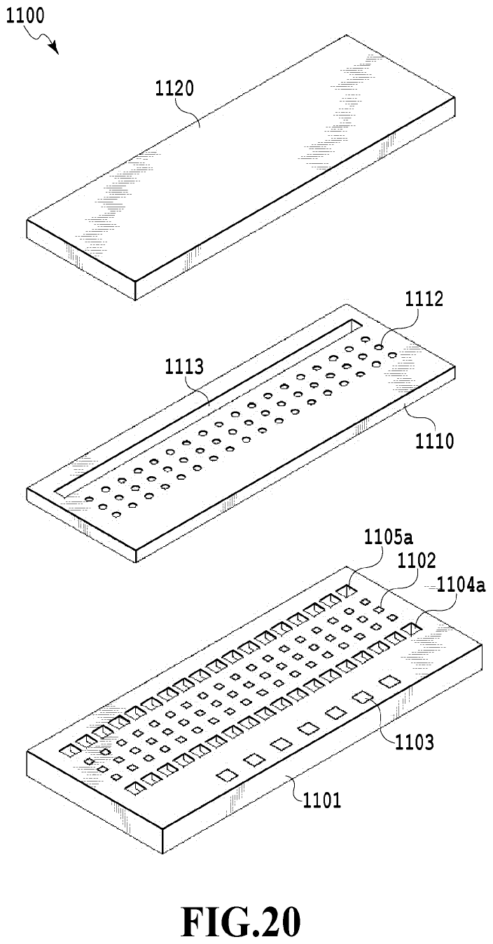

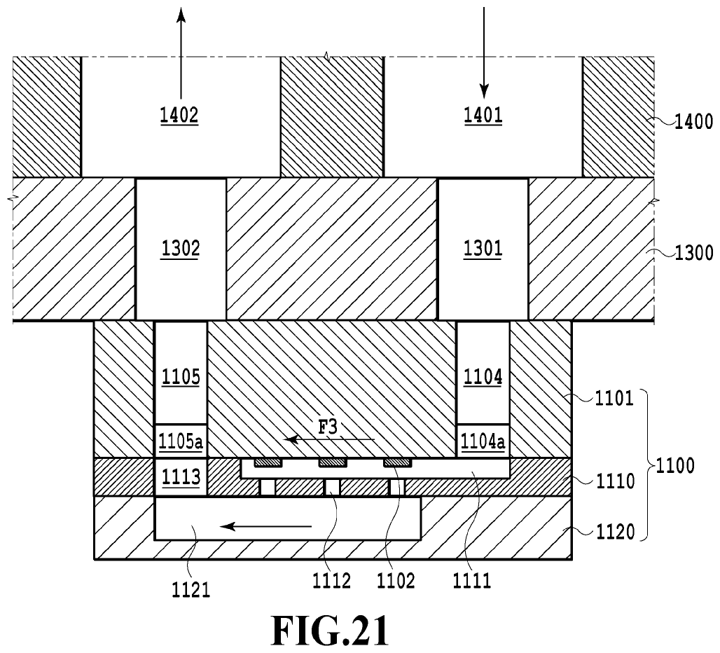

FIG. 18 is a perspective view illustrating an exterior of the UFB generating unit 1000 in the present embodiment, and FIG. 19 is an exploded perspective view of the UFB generating unit 1000. FIG. 20 is an exploded perspective view of the heating element substrate 1100 in the present embodiment, and FIG. 21 is a cross-sectional view taken along XXI-XXI in FIG. 18.

The heating element substrate 1100 in the present embodiment includes the first flow passage member 1110 and a second flow passage member 1120. The ejecting ports 1112 and a collecting passage 1113 are formed in the first flow passage member 1110, and a flow passage 1121 (see FIG. 21) is formed in the second flow passage member 1120. With such a configuration, it is possible to collect and circulate the UFB-containing liquid ejected from the ejecting ports 1112 without using the collecting member 1002 used in the second embodiment. With this, it is possible to implement downsizing and cost reduction of the UFB-containing liquid manufacturing apparatus 2000.

### Fourth Embodiment

A fourth embodiment of the present invention is described with reference to the drawings. The basic configuration of the present embodiment is similar to that of the first embodiment; for this reason, a characteristic configuration is described below.

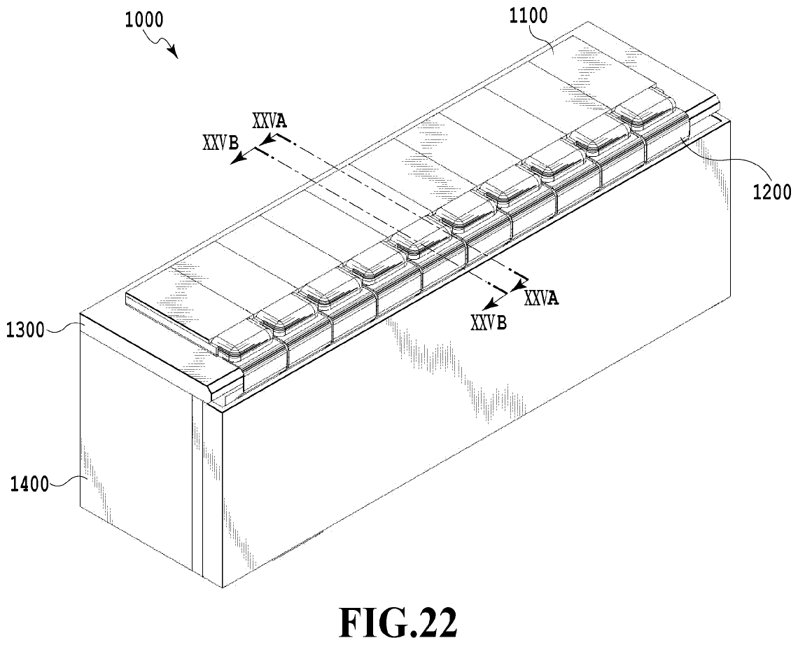

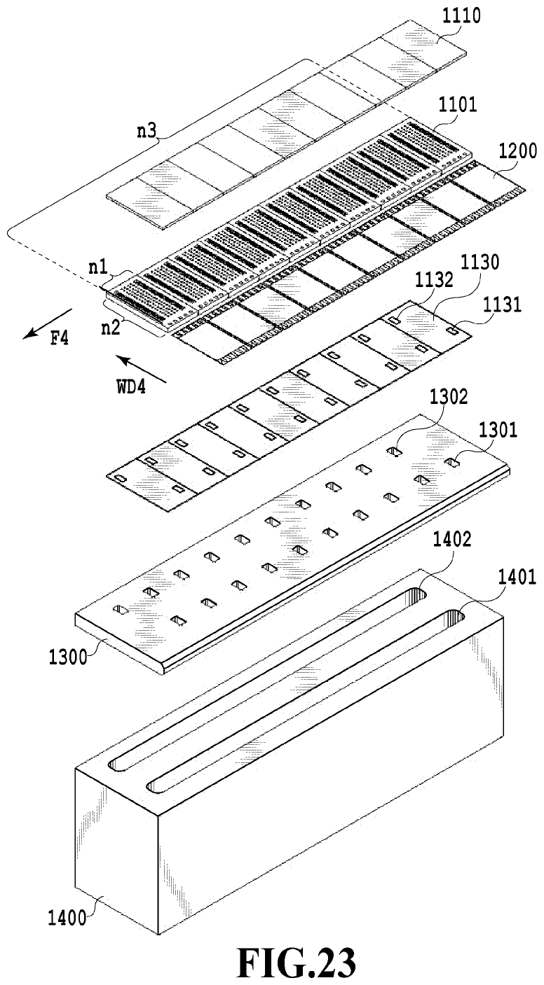

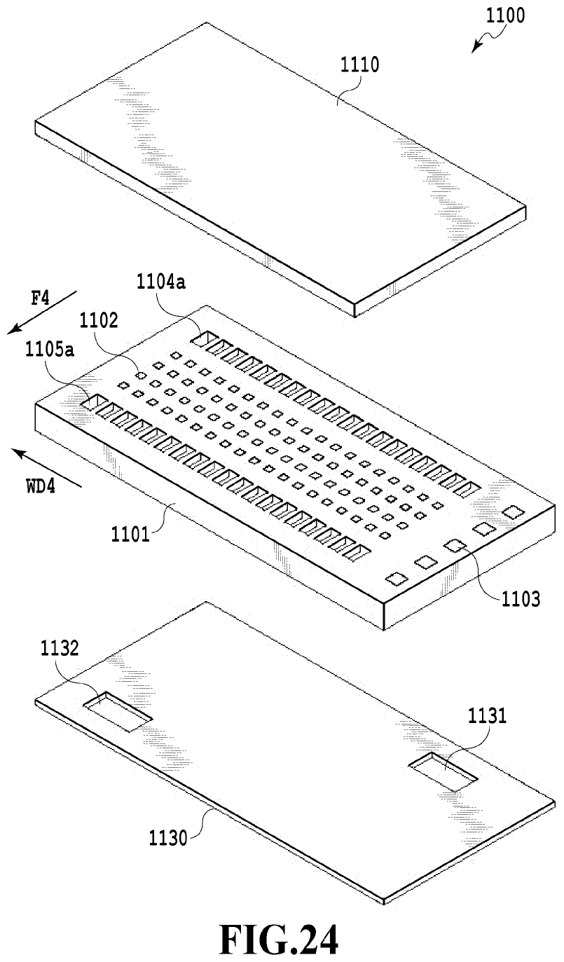

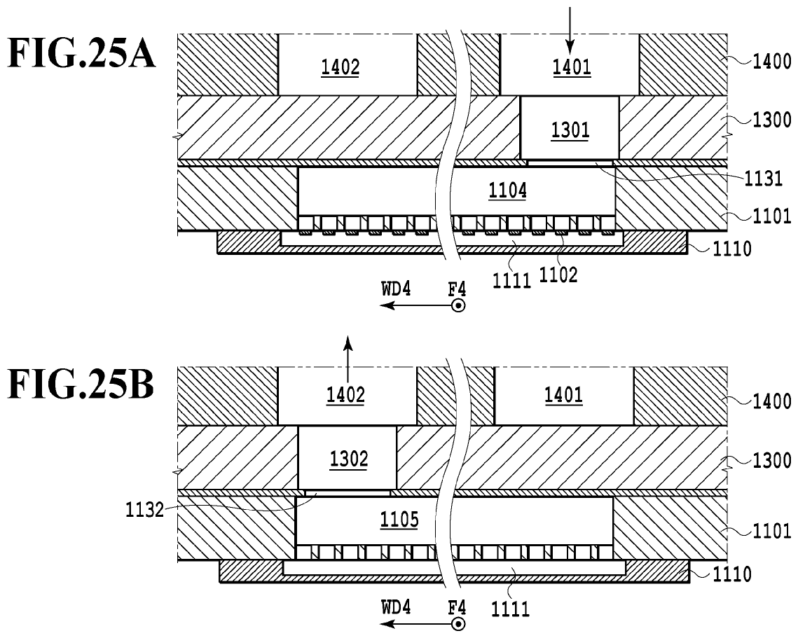

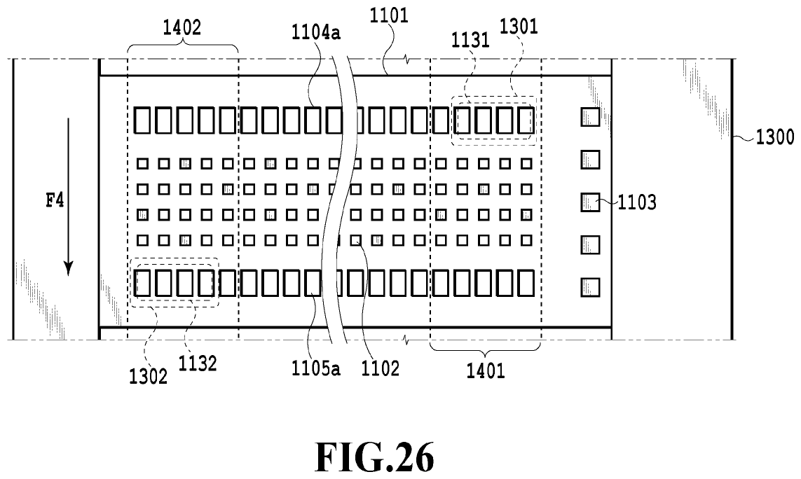

FIG. 22 is a perspective view illustrating an exterior of the UFB generating unit 1000 in the present embodiment, FIG. 23 is an exploded perspective view of the UFB generating unit 1000, and FIG. 24 is an exploded perspective view of the heating element substrate 1100. FIG. 25A is a cross-sectional view taken along XXVa-XXVa in FIG. 22, and FIG. 25B is a cross-sectional view taken along a cross section of XXVb-XXVb in FIG. 22. FIG. 26 is a diagram describing a flow of the liquid in the heating element substrate 1100.

In each embodiment described above, the heating element substrate 1100 is arranged while the longitudinal direction of the UFB generating unit 1000 and the longitudinal direction of the heating element substrate 1100 are in the same direction; however, in the present embodiment, the direction of the heating element substrate 1100 with respect to the UFB generating unit 1000 is different. Specifically, as illustrated in FIG. 22, the heating element substrate 1100 is arranged such that the longitudinal direction of the UFB generating unit 1000 and the transverse direction of the heating element substrate 1100 are in the same direction.

Additionally, as illustrated in FIG. 24, in the heating element substrate 1100 in the present embodiment, a third flow passage member 1130 is provided on a back surface of the heating element substrate 1100 (surface opposite to the direction in which the liquid W is ejected). In the third flow passage member 1130, a supplying port (supply opening) 1131 and a collecting port (collect opening) 1132 are formed. With this, a configuration in which some of the supplying passages 1104 and the collecting passages 1105 are covered with the flow passage member 1130 is applied. In the support member 1300, the supplying passage 1301 and the collecting passage 1302 are formed in the positions corresponding to the supplying port 1131 and the collecting port 1132, respectively.

The liquid W supplied from the supplied liquid chamber 1401 of the housing 1400 is supplied in the order from the supplying passage 1301 of the support member 1300, the supplying port 1131 of the third flow passage member 1130, and the supplying passage 1104 of the Si substrate 1101. The liquid W supplied to the supplying passage 1104 is spread in an arrow WD4 direction in the supplying passage 1104 to flow over the heating elements 1102 of the Si substrate 1101 and, as illustrated in FIG. 26, the liquid W flows in an arrow F4 direction. Thereafter, the liquid W flows from the collecting passage 1105 illustrated in FIG. 25B to the collecting port 1132 and is collected from the UFB generating unit 1000 through the collecting passage 1302 and the collected liquid chamber 1402.

In this case, as illustrated in FIG. 23, in a single heating element substrate 1100, the number of the heating elements 1102 arrayed in the arrow F4 direction, which is the direction in which the liquid flows over the heating elements 1102, is n1, and the number of the heating elements arrayed in the arrow WD4 direction crossing the arrow F4 direction is n2. The total number of the heating elements in the arrow F4 direction in a case where the multiple heating element substrate 1100 is arrayed along the arrow F4 direction is n3. In this case, the UFB generating unit 1000 in the present embodiment has a configuration in which a relationship of n1<n2<n3 is satisfied.

With such a configuration, it is possible to increase the number of the heating elements 1102 arrayed in the arrow WD4 direction; thus, it is possible to mount more heating elements 1102 in the heating element substrate 1100 and to increase the amount of the generated UFBs.

Like the modifications of the first embodiment illustrated in FIGS. 9 and 10, the partition portion 1106 or the partition portion 1107 may be provided. With the partition portion 1106 or the partition portion 1107 being provided, it is possible to suppress the flow of the liquid in the arrow WD4 direction and to suppress the temperature rise of the liquid W; thus, it is possible to generate the UFBs more stably.

### Fifth Embodiment

A fifth embodiment of the present invention is described below with reference to the drawings. The basic configuration of the present embodiment is similar to that of the first embodiment; for this reason, a characteristic configuration is described below.

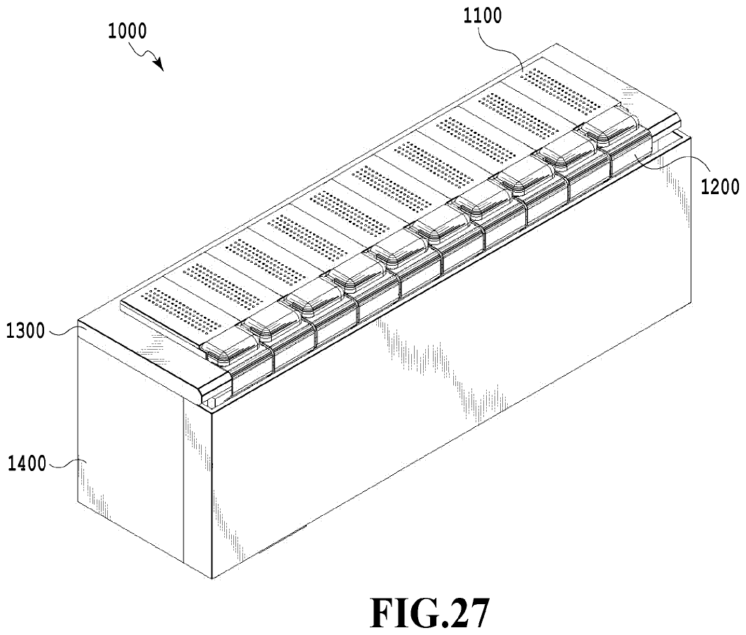

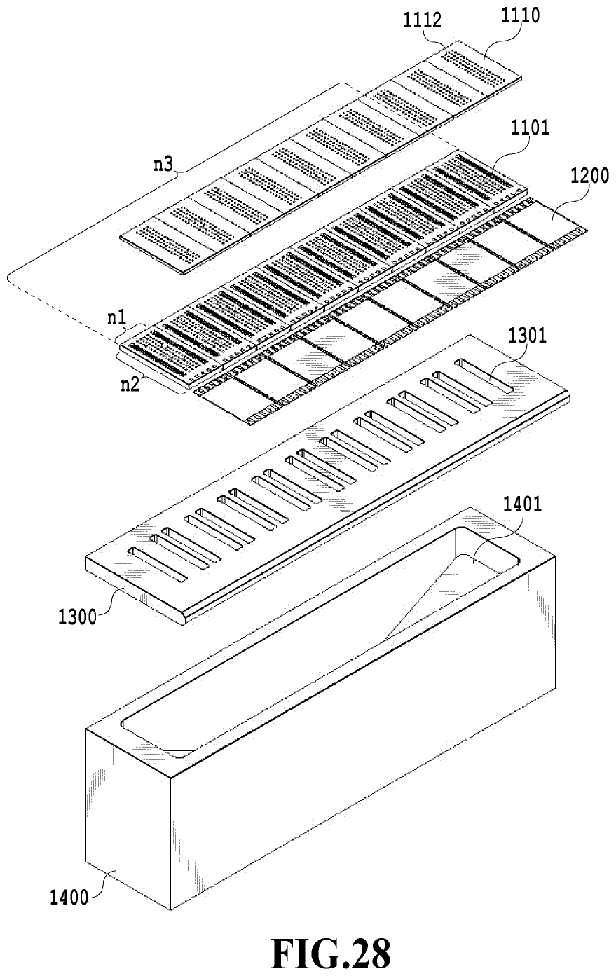

FIG. 27 is a perspective view illustrating an exterior of the UFB generating unit 1000 in the present embodiment, and FIG. 28 is an exploded perspective view of the UFB generating unit 1000. As with the second embodiment, the UFB generating unit 1000 in the present embodiment has a configuration in which the ejecting ports 1112 are provided in the positions corresponding to the heating elements 1102 in the first flow passage member 1110, and the fine droplets are ejected from the ejecting ports 1112 in a case of the bubbling by the heating elements 1102. The relationship between the array in the heating element substrate 1100 and the number of the heating elements 1102 is similar to that described in the fourth embodiment.

However, there is a different point from the fourth embodiment that no third flow passage member 1130 (see FIG. 24) is provided. In the present embodiment, no third flow passage member 1130 is provided. In the fourth embodiment, the supplying passage 1104 and the collecting passage 1105 are formed as flow passages in the same shape in the Si substrate 1101; however, in the present embodiment, both the supplying passage 1104 and collecting passage 1105 function as supplying passages (not illustrated). Additionally, in the support member 1300, openings corresponding to the supplying passages are formed, and those all function as the supplying passage 1301 (see FIG. 28) that supplies the liquid W.

With such a configuration, it is possible to stably generate the UFBs, and it is possible to apply the ejected fine droplets as the UFB-containing liquid in the form of mist. Additionally, with application of the first modification in the second embodiment, it is possible to increase the number of the heating elements 1102 and to increase the amount of the generated UFBs. Moreover, with application of the second modification in the second embodiment to the present embodiment, it is also possible to take out the UFB-containing liquid at a desired concentration by a circulation operation from the storing chamber 900 by opening the valve 904. Furthermore, it is also possible to detach the collecting member 1002 and apply the UFB-containing liquid as the ejected UFB-containing liquid in the form of mist.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-125884 filed Jul. 30, 2021, which is hereby incorporated by reference wherein in its entirety.

What is claimed is:

1. An ultra-fine bubble generating unit configured to generate ultra-fine bubbles in a liquid by heating a plurality of heating elements to make film boiling in the liquid, the ultra-fine bubble generating unit comprising:
a substrate including the heating elements, supplying ports that allow for supplying of the liquid to the heating elements, and a flow passage to guide the liquid supplied from the supplying ports to the heating elements, characterized in that
a relationship of n1<n2 is satisfied in the substrate where
the number of the heating elements arranged along a first direction, which is a direction in which the liquid flows to the heating elements in the flow passage, is n1, and
the number of the heating elements arranged along a second direction, which is a direction crossing the first direction, is n2.

2. The ultra-fine bubble generating unit according to claim 1, wherein
a plurality of the substrates are arrayed along the second direction.

3. The ultra-fine bubble generating unit according to claim 1, wherein
the substrate further includes collecting ports that allow for collecting the liquid from the heating elements, and
the collecting ports are provided downstream of the supplying ports in the first direction.

4. The ultra-fine bubble generating unit according to claim 1, wherein
between the heating elements adjacent to each other in the second direction, a partition wall that separates the heating elements adjacent to each other in the second direction is provided along the first direction.

5. The ultra-fine bubble generating unit according to claim 4, wherein
the partition wall is provided to surround each of the heating elements except a part in the first direction.

6. The ultra-fine bubble generating unit according to claim 1, wherein
the supplying ports are provided upstream and downstream of the heating elements in the first direction.

7. The ultra-fine bubble generating unit according to claim 6, wherein
in the substrate, ejecting ports that allow for ejecting of the liquid are provided in positions corresponding to the heating elements.

8. The ultra-fine bubble generating unit according to claim 7, further comprising:
a collecting member configured to collect the liquid ejected from the ejecting ports.

9. The ultra-fine bubble generating unit according to claim 7, wherein
the substrate is formed by laminating a first flow passage member in which the ejecting ports are provided and a second flow passage member configured to collect the liquid ejected from the ejecting ports on an element substrate in which the heating elements are arranged.

10. The ultra-fine bubble generating unit according to claim 1, wherein
a plurality of the substrates are arrayed along the first direction.

11. The ultra-fine bubble generating unit according to claim 10, wherein
each of the substrates further includes collecting ports that allow for collecting of the liquid from the heating elements, and
the collecting ports are provided downstream of the supplying ports in the first direction.

12. The ultra-fine bubble generating unit according to claim 11, wherein
the substrate is formed by laminating a first flow passage member in which the flow passage is formed and a third flow passage member including a supply opening that allow for supplying of the liquid to the supplying ports and a collecting opening that allow for collecting of the liquid heated by the heating elements on the element substrate in which the heating elements are arranged.

13. The ultra-fine bubble generating unit according to claim 10, wherein
the substrate includes a first flow passage member in which ejecting ports that allow for ejecting of the liquid are provided in positions corresponding to the heating elements .

14. The ultra-fine bubble generating unit according to claim 13, wherein
the n1, the n2, and n3 satisfy a relationship of n1<n2<n3 where
the number of the heating elements arranged along the first direction in a plurality of the substrates arrayed along the first direction is n3.

15. The ultra-fine bubble generating unit according to claim 1, wherein
the n1 pieces of the heating elements arrayed along the first direction are driven concurrently.

16. The ultra-fine bubble generating unit according to claim 1, wherein
the n1 pieces of the heating elements arrayed along the first direction are driven in the order from downstream in the first direction.

17. An ultra-fine bubble-containing liquid manufacturing apparatus, comprising:
an ultra-fine bubble generating unit that includes a substrate including a plurality of heating elements, supplying ports that allow for supplying of a liquid to the heating elements, and a flow passage to guide the liquid supplied from the supplying ports to the heating elements, generates ultra-fine bubbles in the liquid by heating the heating elements to make film boiling in the liquid, and satisfies a relationship of n1<n2 in the substrate where the number of the heating elements arranged along a first direction, which is a direction in which the liquid flows to the heating elements in the flow passage, is n1, and the number of the heating elements arranged along a second direction, which is a direction crossing the first direction, is n2; and
a storing chamber configured to store the liquid to be supplied to the ultra-fine bubble generating unit .

18. The ultra-fine bubble-containing liquid manufacturing apparatus according to claim 17, wherein
the liquid is circulatable between the storing chamber and the ultra-fine bubble generating unit .

19. An ultra-fine bubble generating module that is capable of generating ultra-fine bubbles in a liquid by heating a plurality of heating elements to make film boiling in the liquid, the ultra-fine bubble generating module comprising:
an element substrate in which the heating elements are arranged;
a flow passage member in which a flow passage to guide the liquid to the heating elements is formed; and
a wiring substrate that is connected to the element substrate to supply power to the heating elements, characterized in that
a relationship of n1<n2 is satisfied in the element substrate where
the number of the heating elements arranged along a first direction, which is a direction in which the liquid flows in the flow passage, is n1, and
the number of the heating elements arranged along a second direction, which is a direction crossing the first direction, is n2.
